(19) United States
(12) Patent Application Publication
(10) Pub. No.: US 2015/0087216 A1
(43) Pub. Date: Mar. 26, 2015

(54) SOLAR-POWERED FAN FOR A RECREATION VEHICLE AND SOLAR-POWERED, FAN EQUIPPED VENT COVER THAT FITS ON TOP OF A RECREATIONAL VEHICLE ROOF VENT

(71) Applicant: Stoett Industries, Hicksville, OH (US)

(72) Inventors: Jack Stover, Archbold, OH (US); Dan Joseph Rheaume, Seattle, WA (US)

(21) Appl. No.: 14/495,309

(22) Filed: Sep. 24, 2014

Related U.S. Application Data
(60) Provisional application No. 61/881,862, filed on Sep. 24, 2013.
(60) Provisional application No. 61/900,148, filed on Nov. 5, 2013.

(51) Int. Cl. B60H 1/24; B60H 1/00

(52) U.S. Cl. CPC B60H 1/245; B60H 1/00735
USPC 454/75; 454/136

(57) ABSTRACT

A solar-powered, fan-equipped vent cover is fitted on top of a recreational vehicle roof vent. The vent cover protects the recreational vehicle vent when raining, and includes a solar panel operating a fan to boost the effectiveness of the recreational vehicle roof vent in removing hot air from the recreational vehicle interior living space. The vent cover also includes a battery back-up. The vent cover can also be provided without internal vent fans, and may be in electrical communication with a vent in fluid communication with an interior of the recreational vehicle.

### CROSS REFERENCE TO RELATED APPLICATIONS

This application claims the benefit of U.S. Provisional Application No. 61/881,862, filed on Sep. 24, 2013 and U.S. Provisional Application No. 61/900,148, filed on Nov. 5, 2013. The entire disclosure of each of the above applications is incorporated herein by reference.

### FIELD

The present disclosure relates to a fan for a roof vent and more particularly relates to a solar powered fan for a recreational vehicle roof vent.

### BACKGROUND

Recreational vehicles (RVs) get extremely hot inside without proper ventilation. Although vent covers exist none of them include a solar-powered fan unit that uses the power of the sun to more effectively remove hot air from an RV's interior living space.

### SUMMARY

Concordant and congruous with the present invention, an improved solar-powered fan for RV's has surprisingly been discovered.

According to several aspects, a solar-powered recreational vehicle vent system includes a vent cover. A solar panel inset is connected to an upper wall of the vent cover. A solar panel is supported by the solar panel inset. A vent cover fan grill is connected to the vent cover. A first fan is connected to the vent cover fan grill. Electrical power to operate the first fan is directly provided by the solar panel.

According to other aspects, a solar-powered recreational vehicle vent system includes a vent cover; a solar panel inset connected to an upper wall of the vent cover. A solar panel is supported by the solar panel inset. A vent cover fan grill is connected to the vent cover. A first fan and a second fan are connected to the vent cover fan grill. Electrical power to operate the first fan and the second fan is provided by the solar panel. A rechargeable back-up battery is connected to and charged by the solar panel. The first fan and the second fan are optionally operated by electrical energy stored in the rechargeable back-up battery when solar energy is unavailable for operation of the solar panel.

The present invention protects the interior of the RV during inclement weather, but also includes a solar-powered fan unit that will boost the effectiveness of an RV's vent in removing hot air from the RV's interior living space.

### DRAWINGS

The drawings described herein are for illustrative purposes only of selected embodiments and not all possible implementations, and are not intended to limit the scope of the present disclosure.

FIG. 1 is a top left perspective view of a vent fan housing and system of the present disclosure;

FIG. 2a is a top plan view of the vent fan housing of FIG. 1;

FIG. 2b is a rear end elevational view of the vent fan housing of FIG. 1;

FIG. 2c is a side elevational view of the vent fan housing of FIG. 1;

FIG. 3a is a top plan view of a vent cover fan grill of the vent fan housing of FIG. 1;

FIG. 3b is an end elevational view of the vent cover fan grill of FIGS. 3a; and

FIG. 3c is a side elevational view of the vent cover fan grill of FIG. 3a.

Corresponding reference numerals indicate corresponding parts throughout the several views of the drawings.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The present invention improves upon the device disclosed in U.S. patent application Ser. No. 61/881,862 hereby incorporated herein by reference in its entirety. Elements of the invention may also improve upon the vent fan disclosed in U.S. patent application Ser. No. 13/345,545 hereby incorporated herein by reference in its entirety. The improvements of the invention includes the following:

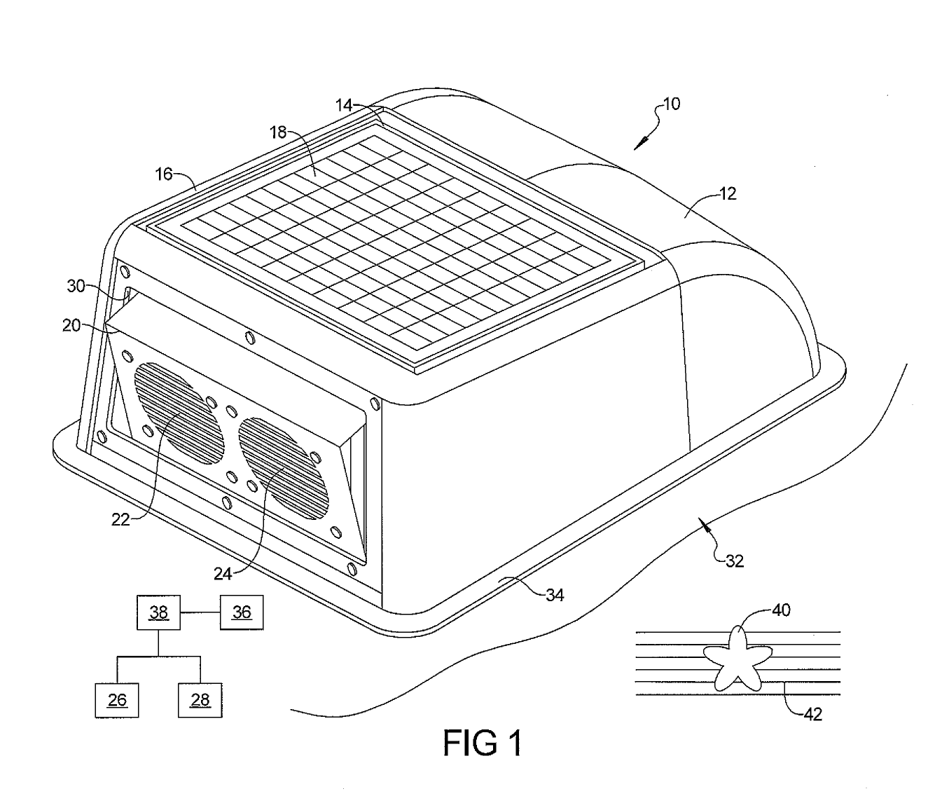

Referring in general to FIGS. 1-3, an RV vent system 10 includes a vent fan housing or vent cover 12 which can be created for example as a molding of a polymeric material. Vent cover 12 includes a solar panel inset 14 which according to several embodiments is connected to an upper wall 16 of the vent cover 12. A solar panel 18 is supported by the solar panel inset 14. A vent cover fan grill 20 which can also be made as a molding of a polymeric material is provided with vent cover 12 which provides support for a first fan 22 and a second fan 24. Electrical power to operate the first fan 22 and the second fan 24 is provided by the solar panel 18. An on/off switch 26 can be provided for manual operation and a thermostat 28 can be provided for automatic operation of the first fan 22 and/or the second fan 24.

To assemble the RV vent system 10 the first fan 22 and the second fan 24 are attached to the vent cover fan grill 20 using clips such as Christmas tree clips. The vent cover fan grill 20 is then inserted into an opening 30 of the vent cover 12 and attached to the vent cover 12 using clips such as Christmas tree clips. The solar panel 18 is then inserted into the solar panel inset 14 and the solar panel inset 14 is connected to the vent cover 12. Electrical connections are made between the solar panel 18 and the first fan 22 and the second fan 24, and to the on/off switch 26 and to the thermostat 28. The vent cover 12 is oriented on the recreational vehicle roof 32 such that the vent cover fan grill 20 is directed facing a back end or rear of the recreational vehicle. An integral flange 34 can be provided with the vent cover 12 to help seal the vent cover 12 to the recreational vehicle roof 32 using for example a gasket and/or a sealant and fasteners.

One embodiment of the invention involves incorporation of a battery back-up-extender 36 that is charged by the solar panel 18. The battery back-up extender 36 will continue running the first fan 22 and/or the second fan 24 when the sun is not present. The battery back-up extender 36 will be re-charged by the solar panel 18 when solar energy to provide recharge energy is available.

In another embodiment, the invention involves incorporating into the vent fan housing 12 the solar panel 18 that will create enough wattage power to operate an existing vent fan (not shown) that is mounted into the RV unit vent opening. This system will not have internal vent fans in the vent housing.

In another embodiment, the invention involves incorporating into the vent fan housing 12 the advanced solar panel 18 and a controller 38 that will operate other RV unit systems that are connected to internal 12 volt DC house batteries of the recreational vehicle. According to several embodiments controller 38 can be connected to the on/off switch 26, to the thermostat 28, and to the battery back-up extender 36. This vent fan solar system 10 will charge 12 volt DC house batteries which will then operate any DC system in the recreational vehicle. In another embodiment, a small 12 VDC vent fan 40 is attached to a back of an RV unit refrigerator (or other electronic device or appliance) inside the RV. The vent fan 40 will blow cool air over the refrigerator coils 42 and make the refrigerator approximately 40% more efficient and use less energy. This option will be powered by the vent fan housing 12 solar panel 18.

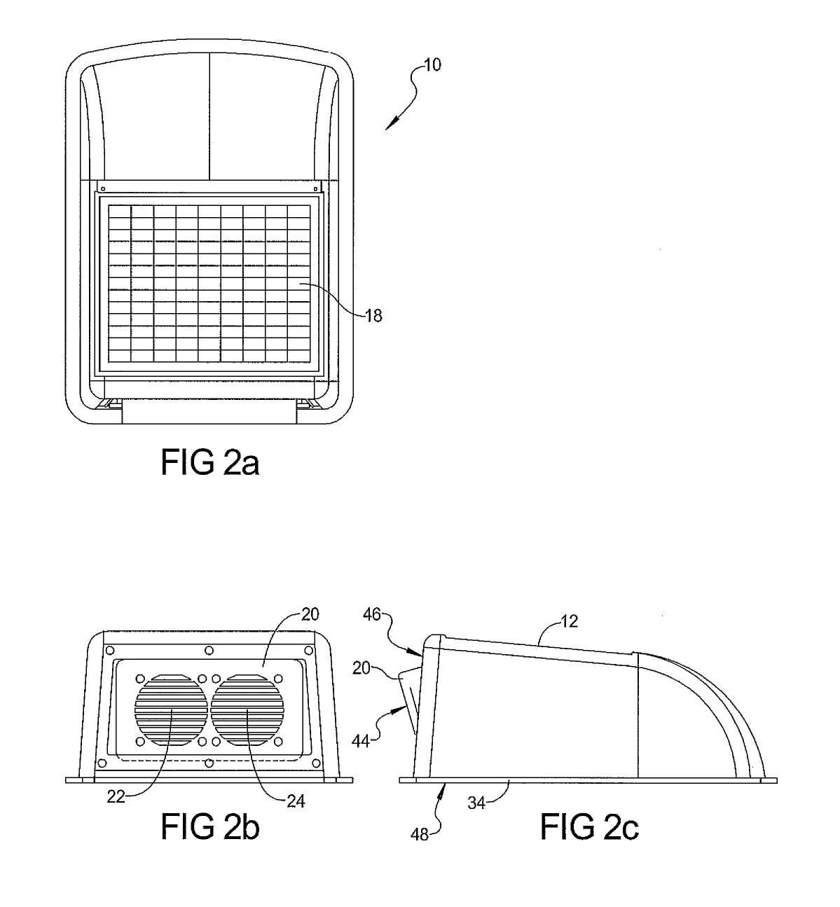

With further reference to FIG. 2c, a face 44 of the vent cover fan grill 20 is angularly oriented with respect to both a rear face 46 of the vent cover fan grill 20 and a planar face 48 defined by the flange 34. The angular orientation of the face 44 helps prevent rain and moisture from entering the vent cover fan grill 20.

With further reference to FIGS. 3c, 1, and 2c, the face 44 of the vent cover fan grill 20 is oriented at an acute angle alpha (a) defined with respect to the rear face 46. Angle alpha (α) is selected to minimize moisture entrance into the vent cover fan grill 20 while providing minimum resistance to heat removal by operation of the first fan 22 and the second fan 24.

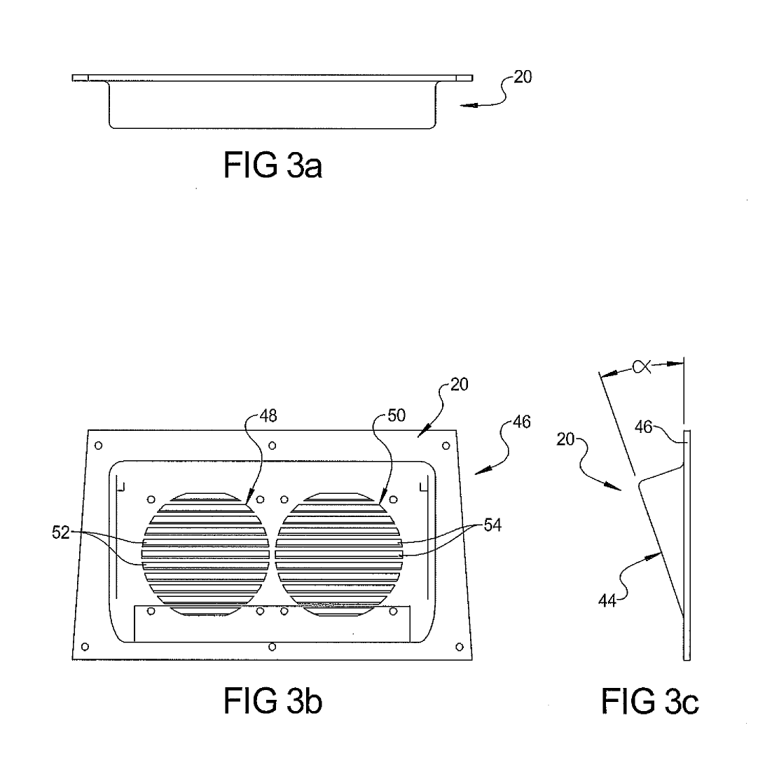

With further reference to FIGS. 3b, 1, and 2b, the vent cover fan grill 20 includes a first grill opening 48 providing multiple louvers 52 at a position of the first fan 22, and a second grill opening 50 providing multiple louvers 54 at a position of the second fan 24. The louvers 52, 54 are directed and open downwardly as viewed in FIG. 3b to help prevent incursion of rain or moisture into the vent cover fan grill 20 and thereby into the vent cover 12.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A solar-powered recreational vehicle vent system, comprising:
a vent cover;
a solar panel inset connected to an upper wall of the vent cover;
a solar panel supported by the solar panel inset;
a vent cover fan grill connected to the vent cover; and
a first fan connected to the vent cover fan grill, wherein electrical power to operate the first fan is directly provided by the solar panel.

2. The solar-powered recreational vehicle vent system of claim 1, further comprising a second fan connected to the vent cover fan grill also directly electrically powered by the solar panel.

3. The solar-powered recreational vehicle vent system of claim 2, further comprising an on/off switch provided for manual operation of the first fan and the second fan.

4. The solar-powered recreational vehicle vent system of claim 2, further comprising a thermostat provided for automatic operation of the first fan and/or the second fan.

5. The solar-powered recreational vehicle vent system of claim 1, wherein the vent cover is a molding of a polymeric material.

6. The solar-powered recreational vehicle vent system of claim 1, wherein the vent cover fan grill is a molding of a polymeric material attached to the vent cover using clips.

7. The solar-powered recreational vehicle vent system of claim 1, further comprising a rechargeable back-up battery connected to and charged by the solar panel, the first fan operated by electrical energy stored in the rechargeable back-up battery when solar energy is unavailable for operation of the solar panel.

8. The solar-powered recreational vehicle vent system of claim 1, further comprising:
a flange integrally connected to the vent cover;
a face of the vent cover fan grill angularly oriented with respect to both a rear face of the vent cover fan grill and a planar face defined by the flange, the angular orientation of the face adapted to prevent rain and moisture from entering the vent cover fan grill.

9. The solar-powered recreational vehicle vent system of claim 8, wherein the face of the vent cover fan grill is oriented at an acute angle defined with respect to the rear face of the vent cover fan grill.

10. A solar-powered recreational vehicle vent system, comprising:
a vent cover;
a solar panel inset connected to an upper wall of the vent cover;
a solar panel supported by the solar panel inset;
a vent cover fan grill connected to the vent cover;
a first fan and a second fan connected to the vent cover fan grill wherein electrical power to operate the first fan and the second fan is provided by the solar panel; and
a rechargeable back-up battery connected to and charged by the solar panel, the first fan and the second fan optionally operated by electrical energy stored in the rechargeable back-up battery when solar energy is unavailable for operation of the solar panel,

11. The solar-powered recreational vehicle vent system of claim 1, further comprising a controller 38 operating RV unit systems connected to internal 12 volt DC house batteries of the recreational vehicle.

12. The solar-powered recreational vehicle vent system of claim 11, further wherein the controller is connected to an on/off switch controlling operation of the first fan and the second fan,

13. The solar-powered recreational vehicle vent system of claim 11, further comprising to a thermostat connected to the controller operating to control operation of the first fan and the second fan.

14. The solar-powered recreational vehicle vent system of claim 10, further comprising a battery back-up extender connected to and charged by the solar panel, the first fan and the second fan operated by electrical energy stored in the rechargeable back-up battery when solar energy is unavailable for operation of the solar panel.

15. The solar-powered recreational vehicle vent system of claim 11, further comprising a 12 VDC vent fan attached to an RV unit refrigerator, the vent fan operated by power generated by the solar panel to blow air over refrigerator coils of the refrigerator.

16. A solar-powered recreational vehicle vent system, comprising:
a vent cover;
a solar panel inset connected to an upper wall of the vent cover;
a solar panel supported by the solar panel inset; and
a rechargeable back-up battery connected to and charged by the solar panel, the solar panel and the rechargeable back-up battery each in electrical communication with a vent device in an interior of the recreational vehicle.

17. The solar-powered recreational vehicle vent system of claim 16, wherein the vent device is a fan.

18. The solar-powered recreational vehicle vent system of claim 17, wherein the fan is in electrical communication with the solar panel and is in fluid communication with a device in an interior of the recreational vehicle.

19. The solar-powered recreational vehicle vent system of claim 16, wherein the vent device is a fan positioned to direct fan forced air over coils of a refrigerator of the recreational vehicle.

20. The solar-powered recreational vehicle vent system of claim 16, further comprising:
a vent cover fan grill connected to the vent cover; and
a first fan and a second fan connected to the vent cover fan grill wherein electrical power to operate the first fan and the second fan is provided by the solar panel.
